(19) United States
(12) Patent Application Publication
(10) Pub. No.: US 2014/0139061 A1
(43) Pub. Date: May 22, 2014

(54) ELECTRIC MACHINE AND CAN FOR THE ELECTRIC MACHINE

(71) Applicant: BAUMUELLER NUERNBERG GMBH, NUERNBERG (DE)

(72) Inventors: FRANK GUTJAHR, ETZELWANG (DE); PETER LEMKE, SCHWABACH (DE); MICHAEL VEEH, KLEINRINDERFELD (DE)

(73) Assignee: BAUMUELLER NUERNBERG GMBH, NUERNBERG (DE)

(21) Appl. No.: 14/164,709

(22) Filed: Jan. 27, 2014

Related U.S. Application Data
(63) Continuation of application No. PCT/EP2012/002365, filed on Jun. 5, 2012.

(30) Foreign Application Priority Data
Jun. 25, 2011 (DE) 202011103647.6

(51) Int. Cl. H02K 9/197

(52) U.S. Cl. CPC H02K 9/197
USPC 310/86

(57) ABSTRACT

An electric machine, in particular an electric motor, has a one-piece can disposed between a stator and a rotor. The can has a tubular casing, which is loaded with external pressure by a coolant in a machine housing and which is made of fiber composite material. The casing thickness of the can lies between 2.5 mm and 0.5 mm. The can is axially fitted onto a sleeve and the sleeve is mounted to a collar of an end plate of the machine housing. The sleeve has a first axial section projecting into the can and a second axial section aligned with the can.

### CROSS-REFERENCE TO RELATED APPLICATION

This application is a continuation, under 35 U.S.C. §120, of copending international application PCT/EP2012/002365, filed Jun. 5, 2012, which designated the United States; this application also claims the priority, under 35 U.S.C. §119, of German patent application No. DE 20 2011 103 647.6, filed Jul. 25, 2011; the prior applications are herewith incorporated by reference in their entirety.

### BACKGROUND OF THE INVENTION

### Field of the Invention

The invention relates to an electric machine having a one-piece can which is arranged between a stator and a rotor, and whose tubular casing, which is loaded with external pressure by way of a cooling fluid within machine housing, is composed of composite fiber material.

The term “electric machine” is understood in this context to mean, in particular, an electric motor or generator, preferably with an integrated converter, as an output of an assembly or auxiliary assembly of a utility vehicle which operates as a motor and/or generator.

The electric machine is typically operated by way of power electronics (converter, in particular frequency converter, DC/AC or AC/DC converter or the like). The electronics suitably have a bridge circuit composed of semiconductor switches whose number depends, like the number of bridge branches, on the phase number of the electric machine. Typically, three-phase motors or multi-phase motors and generators are customary.

Depending on the operation of the electric machine as a motor or as a generator, the electric power is fed either to the machines for the desired rotational speed and the intended torque, or the electric power is extracted from the electric machine and extracted for assemblies downstream, for example a utility vehicle. In the operating mode as a generator, the multi-phase alternating current which is produced in the generator mode is converted by means of the electronics (converter) into a direct current which is then fed, for example, to the respective assembly or load via an intermediate circuit.

The stator of the electric machine is cooled by way of a cooling fluid or coolant in order to dissipate the heat that is generated owing to the power loss caused by operation. The cooling fluid is selected as a function of the field of use and of the power of the electric machine, wherein usually oil is used. The cooling fluid is preferably conveyed by way of a pump which is actuated by the electric machine itself or by means of a separate drive.

In order to avoid the rotor of the electric machine being braked by the cooling fluid owing to the increased friction and therefore the efficiency level of the electric machine being reduced, the latter are provided with a so-called can. This can is located at least partially in the gap between the stator and the rotor and separates them from one another. Conventional cans are composed, for example, of metal or glass-fiber-reinforced plastic.

German published patent application DE 10 2009 052 932 A1 describes an electric machine having a stator inside a stator housing. The stator comprises a coil package which has an axially extending effective area. The coil package is configured therein in order to interact electro-dynamically with the rotor. The winding heads of the coil package are arranged outside the effective area here. The stator housing is separated hermetically from the rotor of the electric machine by means of a can. The can extends axially only at the effective area of the coil package, and is therefore comparatively short.

### SUMMARY OF THE INVENTION

It is an object of the invention to provide an electric machine and a can for such an electric machine, which overcome a variety of disadvantages of the heretofore-known devices of this general type and which provide for an improved electrical machine.

With the foregoing and other objects in view there is provided, in accordance with the invention, an electric machine, comprising:

a machine housing with an end plate;

a stator, a rotor, and a one-piece can disposed between the stator and the rotor;

the can having a tubular casing composed of a composite fiber material and loaded with external pressure by way of a cooling fluid within the machine housing;

the can having a casing thickness less than 2.5 mm and greater than 0.5 mm;

the can being axially fitted onto a sleeve and the sleeve being fitted onto a collar of the end plate of the machine housing; and

the sleeve having a first axial section projecting into the can and a second axial section adjoining the first axial section and aligned with the can.

The electric machine is, for example, an electric generator or, particularly preferably, an electric motor. The electric machine has a stator composed, in particular, of a ferromagnetic material. For example, the stator comprises a number of laminations joined together to form a laminated core, the laminations being arranged essentially perpendicularly with respect to an axial direction of the electric machine. In particular, the laminations are rectangular or circular. In addition, the stator has a coil package with electric conductors which run in the axial direction and which are wrapped around the laminations and/or guided through the laminations in grooves (ducts) provided for that purpose. Arranged outside the laminated core are winding heads which connect the axially extending conductors to one another electrically.

The stator has a cutout running centrally and in the axial direction, a rotor being arranged inside said cutout in a rotor space. The rotor is freely movable here in a rotational direction. In other words, it is possible to rotate the rotor about a rotational axis which extends in the axial direction without said rotor touching the stator. The rotor is constructed, for example, from a laminated core on which or in which, in particular, a number of permanent magnets or electromagnets are mounted. It would also be conceivable for the rotor not to have a magnet, in the manner of an induction motor.

The rotor is made to rotate by energizing the laminated core of the stator, or rotation of the rotor brings about a flow of electric current inside the laminated core. In this context, the electromagnetic field which forms between the rotor and the stator, in particular in the region of the laminated core of the rotor and/or the stator, is essentially constant and, in particular, at a maximum, but at least comparatively large. The region of the comparatively large electromagnetic field is referred to as the effective area. In particular, the term effective area refers to that region between the rotor and the stator whose axial projection is covered by a projection onto the axial direction of at least one of the laminated cores of the stator or of the rotor.

The flow of the electric current through the coil package heats up the stator. In order to avoid damage to the stator, the latter is therefore cooled by means of a cooling fluid. The cooling fluid is, for example, an oil which has, in particular, the property of an electrical insulator.

For example, the comparatively cold cooling fluid is conducted into a stator space which accommodates the stator. The cooling fluid washes around the laminations of the stator and/or within the laminations there are cooling ducts through which the cooling fluid is directed. In this way, the cooling fluid is heated and the stator is cooled. The heated cooling fluid is pumped out of the stator space or conveyed out of it and cooled outside the machine housing, in particular by means of a heat exchanger. In order to ensure that the cooling fluid flows through the stator space, the cooling fluid is expediently under pressure.

In order to avoid the cooling fluid penetrating the rotor space, a can is located between the rotor and the stator. This makes it possible to keep the rotor space free of the cooling fluid, with the result that when the latter rotates comparatively low losses occur. In particular, what are referred to as churning losses of the rotor are avoided by means of the can.

The can is in one piece and a hollow cylinder with a tubular casing which is manufactured from a composite fiber material. In other words, the tubular casing is composed of one fiber or a number of fibers which is/are embedded in a so-called matrix. The thickness of the tubular casing, that is to say the radial extent of the tubular casing between the internal diameter and the external diameter thereof is between 2.5 mm and 0.5 mm. In this way, the can is stable with respect to external pressure and buckling failure of the can can be prevented. Nevertheless, the can is comparatively thin, with the result that the electric machine has a comparatively high efficiency level.

The can is suitably surrounded directly by the stator and, in particular, by the laminated core thereof. At any rate, a gap between the can and the stator is comparatively small. The stator therefore preferably has a stabilizing effect on the can, the casing thickness of which can therefore be reduced. In the case of comparatively large loading with external pressure the can would buckle inwards. Regions of the can would be pressed outward in the course of the inward buckling. For example, in the case of a freely located can and loading with external pressure in a pressure direction which runs through the central axis of the can, these regions are located in an extension direction which also runs through the central axis of the can but perpendicularly with respect to the pressure direction. In other words, the circuit cross section of the can would be deformed elliptically owing to this loading with external pressure. Since the stator which is applied to the can prevents this deformation toward the outside, the buckling of the can toward the inside is reliably prevented.

In one preferred embodiment of the invention, the casing thickness of the can is less than 2 mm and greater than 1 mm and, in particular, the casing thickness is greater than 1.2 mm and, in particular, less than 1.7 mm. The casing thickness is particularly preferably between 1.3 mm and 1.5 mm and, in particular, 1.4 mm.

The can expediently extends over the effective area between the stator and the rotor. In particular, at least the can is longer than the laminated core of the stator and arranged inside the stator in such a way that the entire laminated core is shielded from the rotational axis. This makes it possible to keep the effective area essentially free of ferromagnetic materials which have an adverse effect on the efficiency level of the electric machine. If, specifically, such a material were located there, parasitic electric currents could arise therein, which could weaken the electromagnetic field.

Although the susceptibility of the can buckling owing to a high external pressure increases as a function of the increasing length of the can, that is to say the critical buckling pressure decreases, this increase becomes smaller as a function of the increasing length of the can. In contrast, the casing thickness of the can is dependent in an essentially quadratic fashion on the external pressure. Although the critical buckling pressure is therefore slightly reduced, during the manufacture of the electric machine there are no fabrication problems owing to any connection of the can to further elements within the stator.

In particular, the fiber of the composite fiber material is wound at a winding angle with respect to the longitudinal direction of the can tube during the manufacture of the can. A winding angle of 90° denotes an angle which is perpendicular with respect to the longitudinal direction of the can tube. A can having a winding angle of 90° would accordingly be constructed essentially from a number of rings arranged in a row.

In one expedient embodiment of the invention, the angle is, however, less than 90° and greater than 70°. The winding angle is suitably greater than 75° here. In this way, a comparatively high degree of stability of the can is realized in the radial direction without having to tolerate the possibility of the can falling apart into individual disks.

The fiber is preferably composed of glass and the composite fiber material is a glass-fiber-reinforced plastic (GFP). The plastic is, in particular, epoxy resin. It would also be conceivable for the composite fiber material to be a carbon-fiber-reinforced plastic (CFP).

In one particularly suitable embodiment of the invention, the winding angle is greater than 80° and is at least 82°. In particular, the winding angle is 88° since it has been shown that a winding angle of 88° brings about a particularly high level of stability of the can in the radial direction and at the same time has a level of axial stability which is suitable for the use within the electric machine.

A coating layer is expediently applied to the tubular casing of the can. The coating layer surrounds the can on the outside and is therefore located between the stator and the can, wherein the latter bears against the can. The coating layer prevents the cooling fluid penetrating the can, which in this way could be softened or damaged in some other way. The coating layer is preferably composed of a polymer.

The at least front face, but suitably both front faces of the can, is/are advantageously not in contact with any other element of the electric machine. However, at least the can is not loaded on the front face, which leads to comparatively low mechanical loading of the can in the axial direction. This makes it possible to optimize the can, particularly with respect to the radial stability thereof.

The can is preferably fitted axially onto a sleeve. The sleeve bears on the inside against the can and serves as a positioning element for the can. Owing to the fact that the sleeve bears on the inside of the can, the front faces thereof can be free, that is to say without any contact. Likewise, the sleeve acts as a means of stiffening the can in the radial direction. The sleeve is composed, in particular, of a steel (stainless steel) and does not project into the effective area between the stator and the rotor.

The sleeve is fitted onto a collar of an end plate of the machine housing. The collar of the end plate runs accordingly in the radial direction within the sleeve. The collar is connected, for example, in one piece to the end plate. The can is expediently fitted on both sides onto a sleeve, which is in turn fitted in each case onto a collar.

The use of the sleeve which is fitted onto the collar of the end plate onto which the can is fitted can be independent of the casing thickness or of the rest of the configuration of the can and is instead considered to be an independent invention.

In one advantageous form of the invention, the sleeve is divided in the axial direction into a first axial section and a second axial section or has at least the latter. The first axial section is located at least partially in the can and therefore is in direct or indirect contact with the can, for example via a gasket. In this case, the radial distance between the outermost surface of the first section and the rotational axis is essentially the same or only comparatively slightly smaller than the radial distance of the innermost surface of the can.

The second axial section adjoins the first axial section and the outermost surface of said second axial section has a radial distance from the rotational axis which corresponds essentially to the radial distance between the outer casing face of the can and the rotational axis. In other words, the second axial section is aligned with the can.

During the manufacture of the can, the fiber is, for example, applied directly to the sleeve and therefore produces a fixed connection between the sleeve and the can. However, in one suitable embodiment the can is manufactured separately from the sleeve. So that the cooling fluid does not pass through between the sleeve and the can when there is a raised pressure, a gasket is located between the sleeve and the can. The gasket is, in particular, an O-ring.

The sleeve is expediently sealed with respect to the collar of the end plate by means of a further gasket. The electric machine therefore requires comparatively few sealing points, which sealing points could constitute a residual risk of leaks.

The axial thermal expansion of the machine housing is expediently essentially the same as that of the can. For example, the winding angle and/or the material of the fiber of the can and/or the plastic thereof are suitably selected for this. It would also be conceivable to adapt the machine housing to the can. In this way, when the electric machine heats up during operation the can and the machine housing expand essentially uniformly so that no leaks, through which, for example, the cooling fluid could enter the rotor space, occur between the can and the housing. Likewise, mechanical loading of the can and of the machine housing in the axial direction is avoided if the connection between them is comparatively strong.

The electrical machine expediently has a power level which is less than 1 MW and advantageously between 50 kW and 0.5 MW. In particular, the electric motor has a power level below 500 kW during normal operation, wherein, in particular, during any overload operation the power level is briefly higher than this limit. With these power limits it is usually necessary to cool the stator with the cooling fluid. In this context, the cooling fluid is suitably below a pressure of up to 3 bar in order to ensure the cooling fluid flows through the stator. With this pressure the can does not buckle out in the direction of the rotor and the reliable operation of the electric machine is ensured.

Other features which are considered as characteristic for the invention are set forth in the appended claims.

Although the invention is illustrated and described herein as embodied in an electric machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a sectional illustration of an electric machine having a can; and

FIG. 2 is a perspective view of the can.

### DETAILED DESCRIPTION OF THE INVENTION

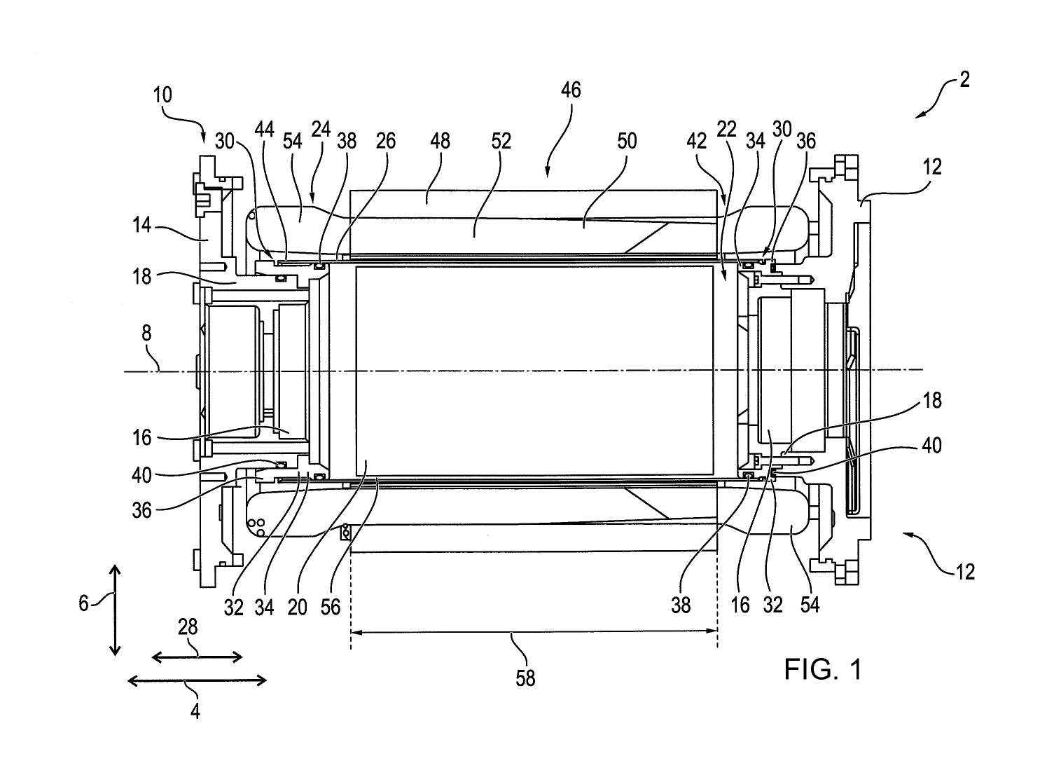

Referring now to the figures of the drawing in detail and first, particularly, to FIG. 1 thereof, there is seen a section through an electric machine 2. A double-arrow 4 indicates an axial direction 4 and a double-arrow 6 indicates a radial direction 6. The section extends along a rotational axis 8, which is parallel to the axial direction 4. The electric machine 2 is, in particular, an electric motor which is used inside a utility vehicle, for example inside a so-called snow groomer, for driving the same or for driving any secondary assemblies. The power level of the electric motor is, for example, 140 kW.

The electric machine 2 has a machine housing 10 made of aluminum, of which an A-side end plate 12 and a B-side end plate 14 are illustrated here. Bearings 16, for example ball bearings, are mounted on the end plates 12, 14. The bearings 16 are each located here inside a collar 18. Each collar 18 is hollow-cylindrical and projects into the interior of the machine housing 10. Within the bearing 16 there is a cylindrical shaft (not illustrated). The shaft is arranged concentrically with respect to the rotational axis 8 and the bearings 16. During the operation of the electric machine 2, the shaft rotates about itself and the rotational axis 8. For input/output the secondary assemblies of the utility vehicle are operatively connected to the shaft.

A schematically shown rotor 20 is concentrically mounted on the shaft. The rotor 20 has, for example, a laminated core composed of individual laminations within which or on which permanent magnets are mounted. In other words, the electric machine 2 is a permanently excited electric motor. The rotor 20 is located inside a rotor space 22 which is filled with air. The rotor space 22 is divided off from a stator space 24 by means of a can 26. The longitudinal direction 28 of the can 26 is parallel to the rotational axis 8 and the axial direction 4.

The can 26 is not loaded at its front faces 30, and therefore no, or comparatively small, axial forces act on the front faces 30 owing to the mounting of the can 26 within the machine housing 10. In order to avoid axial loading of the can 26 during operation of the electric machine 2, the latter has the same thermal expansion in the axial direction 4 as the rest of the machine housing 10. The can 26 and the machine housing 10 therefore have the same temperature coefficient. Therefore if the can 26 expands owing to heat being supplied in the axial direction 4, the machine housing 10 also expands, with the result that there is sufficient space (volume) available to the can 26 inside the machine housing 10 for the thermal expansion without said machine housing 10 tilting.

The can 26 is fitted on both sides onto a sleeve 32 made of steel. Each sleeve 32 has a first axial section 34 and an adjoining second axial section 36. The second axial section 36 is aligned with the outside of the can 26, wherein a free region is located between the second axial section 36 and the front faces 30 of the can 26. The first axial section 34 projects into the can 26 and serves as a mounting point for the can 26.

In other words, the first axial section 34 bears on the inside of the can 26 at least partially directly or indirectly via a further element. In this way, the can 26 is stabilized with respect to inward buckling. In the illustrated electric motor, a gasket 38 in the form of a so-called O-ring made of rubber is located between the first axial section 34 and the can. A depression, within which the gasket 38 is located, is formed in the first axial section 34.

Each sleeve 32 is fitted onto one of the collars 18 and sealed by means of a further gasket 40. The sleeve 32, the gaskets 38, 40 and the can 26 therefore seal the rotor space 22 essentially hermetically with respect to the stator space 26 which is filled with a cooling fluid 42.

While the electric machine 2 is operating, the cooling fluid 42 is at a pressure which is, for example, 3 bar. The can 26 is fabricated in such a way that such a pressure, or else a peak pressure during an overload phase of, in particular, up to 9 bar, does not press the can 26 inward into the rotor space 22 or cause inwardly directed buckles, dents or bends in the can 26. So that the cooling fluid 42 does not penetrate the can 26 itself, the latter is coated on its surface by means of a coating layer 44. The coating layer 44 is composed of a polymer. The cooling fluid 42 is an insulating oil and serves to cool a stator 46 which is arranged inside the stator space 24.

The stator 46 has a laminated core 48 which is composed of a number of laminations stacked one on top of the other. Ducts, through which the cooling fluid 42 can flow, are formed in the laminations, essentially in the axial direction 4. Openings through which a coil package 50 of the stator 46 is inserted are also located inside the laminations. The core package 50 is composed essentially of an electric conductor and has an axial section 52 within which the electric conductor extends mainly parallel to the axial direction 4 and which is located inside the laminated core 48. The axial section 52 is adjoined in the axial direction 4 on both sides by so-called winding heads 54. The electric conductor is turned over inside the winding heads 54 so that the electric conductor is guided again into the axial section 52.

In addition, the laminations of the laminated core 48 have in the center a round cutout within which the can 26 is arranged. The diameter of this cutout is, for example, 150 mm, and the external diameter of the can 26 is, in particular, 0.3 mm less than this. In other words, the external diameter of the can is 149.7 mm, it also being possible for the latter to be larger. The thermal expansion of the can 26 in the radial direction 6 is matched to the stator 46 and, in particular, to the laminated core 48, in a way which is comparable to the thermal expansion in the axial direction 4, which is matched to the machine housing 10.

While the electric machine 2 is operating, the external diameter of the can 26 does not exceed the diameter of the cutout inside the laminated core 48. This avoids damage to the can 26, which can lead to so-called buckling failure, that is to say the destruction of the can 26 and/or penetration of cooling fluid 42 into the rotor space 22.

The can 26 is arranged inside the laminated core 48 in such a way that the latter extends beyond an electromagnetic effective area 56 between the stator 46 and the rotor 20. The effective area 56 is that region between the stator 46 and the rotor 20 inside which the electromagnetic field generated by said stator 46 and rotor 20 is comparatively large and approximately constant. The length 58 of the effective area 56 corresponds in the illustrated electric machine to the length of the laminated core 48. In other words, the can 26 protrudes in the axial direction 4 on both sides of the laminated core 48.

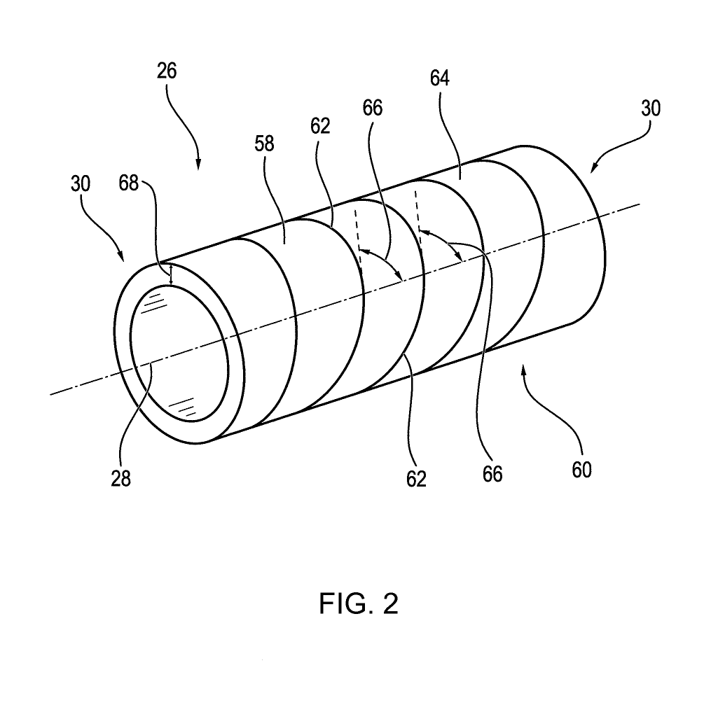

FIG. 2 shows a perspective view of the can 26 which has a tubular casing 58. The tubular casing 58 is hollow-cylindrical and is composed of a composite fiber material 60 with a fiber 62 which is embedded in a matrix 64. The fiber 62 is composed of glass and the matrix 64 is epoxy resin, with the result that the composite fiber material 60 is a glass-fiber-reinforced plastic. The fiber 62 has a winding angle 66 with respect to the longitudinal direction 28 of the can tube. In other words, when the can 26 is manufactured, for example the fiber 62 is wrapped around a blank or rolled thereon at a specific angle, specifically the winding angle 66, wherein the blank is cylindrical and the external diameter thereof corresponds essentially to the internal diameter of the can 26. The intermediate spaces between the individual sections of the fiber 62 are filled in by means of the matrix 64. The winding angle 66 is essentially constant over the length of the can 26, but it can vary in the region of the front faces 30 of the can. The winding angle 66 is 88° at least over a comparatively large length of the can 26.

The casing thickness 68 of the tubular casing 58 is 1.4 mm. The air gap (annular space) between the stator 46 and the rotor 20 can therefore be comparatively small, but, inter alia owing to the selection of the winding angle 66, the can 26 has a comparatively high level of stability and keeps the cooling fluid 42 securely within the stator space 24.

The invention is not restricted to the exemplary embodiment described above. Instead, other variants of the invention can also be derived therefrom by a person skilled in the art without departing from the subject matter of the invention. In particular, in addition all the individual features described in relation to the exemplary embodiment can also be combined with one another in another way without departing from the subject matter of the invention.

The following is a summary list of reference numerals and the corresponding structure used in the above description of the invention:
2 Electric machine
4 Axial direction
6 Radial direction
8 Rotational axis
10 Machine housing
12 A-side end plate
14 B-side end plate
16 Bearing
18 Collar
20 Rotor
22 Rotor space
24 Stator space
26 Can
28 Longitudinal direction of the can tube
30 Front face
32 Sleeve
34 First axial section
36 Second axial section
38 Gasket
40 Gasket
42 Cooling fluid
44 Coating layer
46 Stator
48 Laminated core
50 Coil package
52 Axial section
54 Winding head
56 Effective area
58 Tubular casing
60 Composite fiber material
62 Fiber
64 Matrix
66 Winding angle
68 Casing thickness

1. An electric machine, comprising:
a machine housing with an end plate;
a stator, a rotor, and a one-piece can disposed between said stator and said rotor;
said can having a tubular casing composed of a composite fiber material and loaded with external pressure by way of a cooling fluid within said machine housing;
said can having a casing thickness less than 2.5 mm and greater than 0.5 mm;
said can being axially fitted onto a sleeve and said sleeve being fitted onto a collar of said end plate of said machine housing; and
said sleeve having a first axial section projecting into said can and a second axial section adjoining said first axial section and aligned with said can.

2. The electric machine according to claim 1, which comprises a gasket (38/40) sealing said sleeve with respect to said can and a gasket sealing said sleeve with respect to said collar.

3. The electric machine according to claim 1, wherein said casing thickness of said can is less than 2 mm and greater than 1 mm.

4. The electric machine according to claim 1, wherein said casing thickness of said can is 1.4 mm.

5. The electric machine according to claim 1, wherein said can extends in a longitudinal direction of said can beyond an electromagnetic effective area between said stator and said rotor.

6. The electric machine according to claim 1, wherein said composite fiber material is a glass-fiber-reinforced plastic and a winding angle between a longitudinal direction of said can and a fiber of said composite fiber material is less than 90° and greater than 70°.

7. The electric machine according to claim 6, wherein said winding angle is greater than 75°.

8. The electric machine according to claim 6, wherein said winding angle is greater than 80°.

9. The electric machine according to claim 6, wherein said winding angle between the longitudinal direction and the fiber is 88°.

10. The electric machine according to claim 1, wherein said tubular casing is coated on an outside with a coating layer.

11. The electric machine according to claim 10, wherein said coating layer is a polymer.

12. The electric machine according to claim 1, wherein said machine housing has axial thermal expansion equal to a thermal expansion of said can in the longitudinal direction of said can.

13. The electric machine according to claim 1, configured for a power level of less than 1 MW.

14. The electric machine according to claim 13, configured for a power level between 50 kW and 500 kW.

15. The electric machine according to claim 13, configured as an electric motor,

16. A can assembly for an electric machine, comprising:
a one-piece tubular casing configured for placement between a stator and a rotor of the electric machine;
said tubular casing being composed of a composite fiber material and configured for loading with external pressure by way of a cooling fluid within a machine housing of the electric machine;
said tubular casing having a casing thickness between 2.5 mm and 0.5 mm;
said tubular casing being axially fitted onto a sleeve that is disposed on a collar of an end plate of the machine housing; and
wherein a first axial section of the sleeve projects into the can and a second axial section adjoining the first axial section is aligned with the can.
